(19) United States
(12) Patent Application Publication
(10) Pub. No.: US 2024/0379274 A1
(43) Pub. Date: Nov. 14, 2024

(54) TRANSFORMER

(71) Applicant: Vitesco Technologies GmbH, München (DE)

(72) Inventor: Michael DECKER, München (DE)

(21) Appl. No.: 18/687,079

(22) PCT Filed: Aug. 19, 2022
(86) PCT No.: PCT/EP2022/073154

§ 371 Date: Feb. 27, 2024

(30) Foreign Application Priority Data
Aug. 31, 2021 (DE) 10 2021 209 537.2

(51) Int. Cl. H01F 27/22; H01F 3/14; H01F 27/40

(52) U.S. Cl. CPC H01F 27/22; H01F 3/14; H01F 27/402; H01F 2027/406

(57) ABSTRACT

A transformer is disclosed. The transformer has: a magnetic core structure which has two side limbs and one central limb connected to the side limbs. A first winding is arranged around the central limb, and a second winding is arranged around the central limb. The central limb has an air gap which is filled with an electrically non-conductive and magnetically non-conductive insulation element which has a plurality of bores extending through the insulation element and provided with copper plating. The bores are not electrically connected to one another and extend perpendicularly to the air gap.

### CROSS REFERENCE TO RELATED APPLICATIONS

This application is the U.S. National Phase Application of PCT International Application No. PCT/EP2022/073154, filed Aug. 19, 2022, which claims priority to German Patent Application No. 10 2021 209 537.2, filed Aug. 31, 2021, the contents of such applications being incorporated by reference herein.

### FIELD OF THE INVENTION

The present invention relates to a transformer.

### BACKGROUND OF THE INVENTION

Transformers are usually used as components for transforming current and voltage. As is the case for every electrical component, the transformer also has losses when current and voltage are transformed. The waste heat created must be dissipated sufficiently well in order to avoid component-critical temperatures. This is the case in particular when the transformer has to be designed for high-voltage applications.

### SUMMARY OF THE INVENTION

An aspect of the present invention is a transformer which is characterized by effective dissipation of waste heat created in the transformer.

In accordance with a first aspect of the present invention, a transformer is provided. The transformer may be, for example, a shell-type transformer. The transformer comprises a magnetic core structure which has two side limbs and one central limb connected to the side limbs. The transformer moreover comprises a first winding arranged around the central limb, and a second winding arranged around the central limb which interacts with the first winding and the magnetic core structure in order to transform current and voltage. The transformer according to an aspect of the invention has, in the central limb, an air gap which is filled with an electrically non-conductive and magnetically non-conductive insulation element which has a plurality of bores which extend through the insulation element, are provided with copper plating, and are not electrically connected to one another.

The transformer according to an aspect of the invention is based at least partly on the insight that the air gap present in the central limb is usually a poor conductor of heat and as a result waste heat which is created in particular during operation of the—transformer can be dissipated by the air gap only insufficiently. The air gap is, however, required because it prevents premature saturation of the transformer, in particular in the case of high currents. The air gap is referred to as an air gap because it is not magnetically and electrically active. It is not unusual to provide an air gap in the case of transformers. The transformer according to an aspect of the invention is, however, based at least partly on the recognition that the insufficient heat dissipation present through the air gap can be improved by means of an electrically non-conductive and magnetically non-conductive insulation element which fills the air gap. The fact that the insulation element is electrically and magnetically non-conductive ensures that the air gap filled with the insulation element remains magnetically and electrically inactive. The transformer according to an aspect of the invention is moreover based at least partly on the insight that the thermal conductivity of the magnetically and electrically inactive insulation element can be improved by a plurality of bores which extend through the insulation element, are provided with copper plating, and are not electrically connected to one another. Such bores in the insulation element can also be called vias. Such bores have a small copper sleeve on the circumferential surface of the bores by virtue of the copper plating which is created, for example, by a process of galvanizing copper on the circumferential surface of the bores. This copper sleeve is characterized by a particularly high thermal conductivity because copper has a relatively high thermal conductivity as a metal. The transformer according to an aspect of the invention is additionally based at least partly on the insight that this relatively high thermal conductivity can be used for the efficient dissipation of heat in the transformer when the copper-plated bores additionally have no electrical connection and are electrically insulated from one another. This is because undesired eddy current effects, which would restrict the functionality of a transformer, are avoided or minimized by the bores which are insulated from one another. As a result, a transformer is provided which has an improved heat dissipation with a relatively constant efficiency. Such transformers can in particular also be used in high-voltage applications in which an effective dissipation of heat is required.

The bores here extend perpendicularly to the air gap in the central limb and perpendicularly to a central plane, extending in the direction of longitudinal extent of the air gap, of the air gap such that there is an efficient dissipation of heat perpendicularly to the plane of longitudinal extent of the air gap in the central limb.

It is particularly advantageous if the electrically non-conductive and magnetically non-conductive insulation element is a glass fiber-reinforced resin element. Glass fiber-reinforced resin elements are known, for example, as material for printed circuit board elements. The particularly advantageous configurations therefore provide for the use of a printed circuit board which can, for example, be an FR4 printed circuit board, as an insulation element. Such printed circuit boards can also have the vias already described above such that correspondingly designed printed circuit boards can be used as an insulation element in the air gap. Glass fiber-reinforced resin elements as an insulation element additionally have the advantage over other insulation elements, such as for example ceramic elements, of more simple manufacture because the risk of breaking is lower in the case of glass fiber-reinforced resin elements than in the case of ceramic elements. In addition, glass fiber-reinforced resin elements are solid items which can be obtained cost-effectively.

A further advantageous configuration of the transformer according to an aspect of the invention provides that the plurality of bores are arranged in the insulation element in a uniform pattern. Within the scope of this disclosure, a uniform pattern refers to an arrangement of bores which have the same spacing from one another. As a result, a uniform dissipation of heat over the cross-sectional surface area of the insulation element is ensured. In addition, the thermally conductive surface area provided by the insulation element is optimally used by the patterned arrangement of the vias. It is particularly advantageous if the pattern is a hexagonal pattern because a higher packing density can be obtained in the insulation element as a result.

A further advantageous configuration provides that the insulation element has copper cladding, connected to the copper plating, on an upper side and/or a lower side of the insulation element. This advantageous configuration is based at least partly on the knowledge that the copper cladding increases a thermally conductive end surface area of the copper sleeve. Because the bores or the vias have to be electrically insulated from one another, the copper cladding has, in the region of adjacent bores, gaps or interruptions, which prevent electrical conduction between adjacent bores. These interruptions or gaps can be formed, for example, in etching processes or by photostructured templates, on the upper side and/or lower side of the insulation element.

Continuous electrical conduction on the upper side and/or lower side is consequently be prevented, as is the electrical connection of the bores to one another. It is particularly advantageous if the copper cladding has a hexagonal shape in the region of a respective bore. The thermal conductivity at the end sides of the bores is maximized by the hexagonal shape because the thermally conductive surface area on the upper side and/or lower side of the insulation element is maximized. The copper cladding with a hexagonal shape results as it were in optimal coverage of the upper side and/or lower side of the insulation element. It is particularly advantageous if the copper cladding has a hexagonal shape and also if the pattern of the bores is a hexagonal pattern.

A further advantageous configuration provides that an adhesive layer is present between the insulation element and the inner walls of the central limb which form the air gap. This advantageous configuration is based at least partly on the insight that the adhesive layer serves to compensate tolerances and additionally provides wide-area contact between the insulation element and the inner walls of the central limb which form the air gap. The wide-area thermal conduction thus produced between the insulation element and the central limb results in further improved heat dissipation. The adhesive layer can be applied, for example, by means of an adhesive, such as for example a polymer adhesive, or by means of an adhesive film between the insulation element and the inner walls of the central limb.

A further preferred configuration provides that the insulation element consists of a plurality of glass fiber-reinforced resin elements which are arranged one above the other and connected to one another, preferably bonded to one another. This preferred embodiment is based at least partly on the insight that glass fiber-reinforced resin elements which are used as materials for, for example, printed circuit boards usually have a thickness of approximately 0.8 mm to 2 mm. In order to be able to achieve larger air gap thicknesses in transformers, it is therefore proposed to arrange a plurality of such glass fiber-reinforced resin elements one above the other. In order to optimize the heat transfer between the glass fiber-reinforced resin elements, it is proposed to connect them to one another, in particular to bond them to one another. The glass fiber-reinforced resin elements which are arranged one above the other and connected to one another can already have the above described vias, as well as the already above described copper cladding on the respective upper side and/or lower side. As a result, air gap thicknesses can be obtained which have many times the usual thickness of an individual glass fiber-reinforced resin element.

A further preferred configuration provides that the bores are filled with an electrically non-conductive filling material. This preferred configuration is based at least partly on the insight that an electrically non-conductive filling material, such as for example a polymer material, increases the thermal conduction inside the bores. The electrically non-conductive filling material can moreover prevent air pockets in the bores of the insulation element. In addition, the electrically non-conductive filling material enables the formation of an optimally planar surface on the upper side and/or lower side of the insulation element, which is advantageous in particular when an adhesive layer as described above is used.

A further preferred configuration provides that the insulation element has a sensor for determining a parameter which is characteristic for the transformer. Such a parameter can be, for example, a temperature, a magnetic field strength in the air gap, or the like. It is consequently possible to monitor a parameter which is characteristic for the transformer. The sensor can here in particular also be an optical sensor.

A development of this preferred configuration provides that the transformer has a winding carrier, arranged around the central limb, for holding the first and second winding, and that this winding carrier has a recess which is formed as a connection path for connection of the sensor. The connection path can here be formed for the guidance of electrical and/or optical conductors depending on which type of sensor is used.

A further advantageous configuration provides to form the magnetic core structure from two identical magnetic core elements, wherein the air gap is formed centrally between the two magnetic core elements. This advantageous configuration is based at least partly on the insight that the magnetic core structure can be formed by two geometrically identical magnetic core elements, and that a central air gap arranged between the two magnetic core elements is formed automatically when the two magnetic core elements are assembled. The configuration of the magnetic core structure by means of two identical magnetic core elements has a cost advantage in particular in the case of the production or manufacture of the transformer.

A further preferred configuration provides that the central limb has, in addition to the already described air gap, a further air gap which is filled with a further electrically non-conductive and magnetically non-conductive insulation element which for its part has a plurality of bores provided with copper plating and not electrically connected to one another. This preferred configuration is based at least partly on the insight that a leakage inductance of the transformer generated by the insulation elements can be adapted to the respective use case because of the division into a plurality of air gaps which are spaced apart or separated from one another and filled with a respective insulation element. It is particularly advantageous if glass fiber-reinforced resin elements, as are used for example as materials for printed circuit board elements, are employed as insulation elements. This is because in such a case, the insulation elements are generally mass-produced insulation elements such that a thickness of a respective insulation element is subject to narrow tolerances. It is consequently possible to adapt the air gaps spaced apart from one another very precisely in terms of their respective thickness using manufacturing technology. A leakage inductance of the transformer adapted to the respective use case can consequently be mass-produced.

A second aspect of the present invention provides the use of a printed circuit board element, designed as a glass fiber-reinforced resin element and which has a plurality of bores which are provided with copper plating and are not electrically connected to one another, as an electrically non-conductive and magnetically non-conductive insulation element in an air gap formed in a central limb of a magnetic core structure of a transformer.

Advantageous configurations of the transformer according to the first aspect can be considered as advantageous configurations of the second aspect of this invention.

### BRIEF DESCRIPTION OF THE DRAWINGS

Further features and aspects of the present invention will become apparent to a person skilled in the art by practising the present teaching and taking into consideration the accompanying drawings, in which:

FIG. 1 shows a schematic view in section of an embodiment of a transformer according to the invention,

FIG. 2 shows a schematic detailed view of FIG. 1,

FIG. 3 shows a schematic view of an insulation element,

FIG. 4 shows a schematic detailed view with insulation elements arranged one above the other,

FIG. 5 shows a schematic detailed view of a further embodiment of a transformer according to the invention, and

FIG. 6 shows a schematic detailed view of a further embodiment of a transformer according to the invention.

### DETAILED DESCRIPTION OF THE PREFERRED EMBODIMENTS

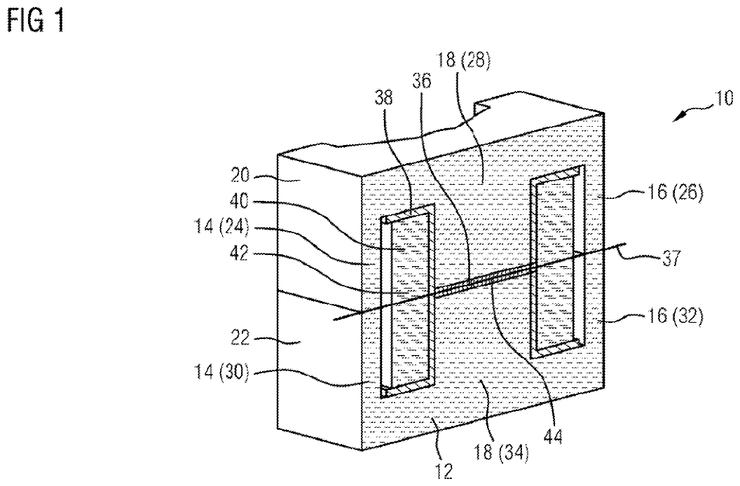

Reference is made first to FIG. 1 which shows a schematic view in section of a transformer 10. The transformer 10 has a magnetic core structure 12 which has a first side limb 14, a second side limb 16, and a central limb 18 connecting the side limbs 14, 16. In the specific example in FIG. 1, the magnetic core structure 12 consists of two identical magnetic core elements with the same shape, namely a first magnetic core element 20 and a second magnetic core element 22, which are connected to each other. The first magnetic core element 20 has a first side limb portion 24, a second side limb portion 26, and a central limb portion 28 connecting the two side limb portions 24, 26. The second magnetic core element 22 has a first side limb portion 30, a second side limb portion 32, and a central limb portion 34 connecting the two side limb portions 30, 32. The two magnetic core elements 20, 22 are here connected to each other in such a way that the first side limb portion 24 of the first magnetic core element 20 form, together with the first side limb portion 30 of the second magnetic core element 22, the first side limb 14 of the magnetic core structure 12. The two magnetic core elements 20, 22 are moreover connected to each other in such a way that the second side limb portion 26 of the first magnetic core element form, together with the second side limb portion 32 of the second magnetic core element 22, the second side limb 16 of the magnetic core structure 12. In addition, the two magnetic core elements 20, 22 are connected to each other in such a way that the central limb portion 28 of the first magnetic core element 20 form, together with the central limb portion 34 of the second magnetic core element 22, the central limb 18 of the magnetic core structure 12.

As can moreover be seen in FIG. 1, the central limb 18 has an air gap 36 which is spanned by two parallel planes, wherein a central plane arranged centrally between the two planes has an air gap axis 37 such that the air gap 36 is arranged centrally between the two central limb portions 28, 34 of the respective magnetic core element 20, 22. The two parallel planes of the air gap 36 are defined by the two end surfaces or end sides of the central limb portions 28, 34 and the central plane is arranged centrally between the two end surfaces or end sides.

The transformer 10 moreover has a winding carrier 38, wherein the winding carrier 38 is arranged around the central limb 18 in such a way that the winding carrier 38 holds a first winding 40 and a second winding 42. The two windings 40, 42 are here wound around the winding carrier 38 in such a way that the transformer 10 can transform current and voltage, as is known to a person skilled in the art in the case of such transformers. Because of the arrangement of the central limb 18, the first side limb 14, the second side limb 16, and the windings 40, 42, the transformer 10 can also be referred to as a shell-type transformer.

More detail will now be given below about the air gap 36 and an insulation element 44, arranged in the air gap 36, which will be described in connection with the further Figures.

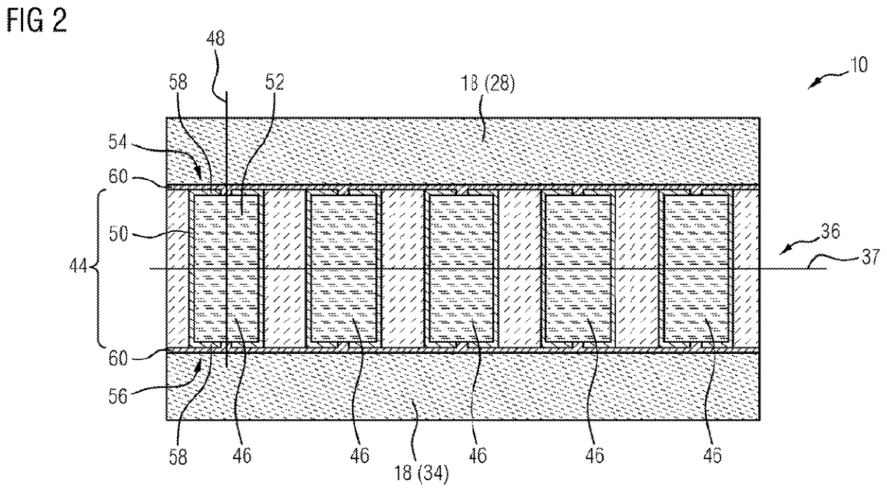

Reference is made first to FIG. 2 which shows a schematic detailed view of FIG. 1. Shown in FIG. 2 is a section of the central limb 18 formed from the two central limb portions 28, 34 and of the air gap 36 formed between the two central limb portions 28, 34.

As can be seen in FIG. 2, the air gap 36 is filled with the already mentioned insulation element 44. The insulation element 44 is electrically non-conductive and magnetically non-conductive. The insulation element 44 is designed such that, for example, eddy current effects in the region of the air gap 36 are avoided. In the specific example, the insulation element 44 is a glass fiber-reinforced resin element which is used, for example, as material for a printed circuit board element, such as for example an FR4 printed circuit board element. In other embodiments which are not shown, the insulation element 44 can, however, also be formed from other expedient materials as long as both electrical and magnetic inactivity of the insulation element 44 are ensured.

The insulation element 44 has a plurality of bores 46 extending through the insulation element 44. A respective bore 46 extends here along a respective bore axis 48. In the specific example of FIG. 2, a respective bore axis 48 of a respective bore 46 extends perpendicularly to the air gap 36 or perpendicularly to its central plane and hence, inter alia, also perpendicularly to the above described air gap axis 37 of the air gap 36.

As can moreover be seen in FIG. 2, a respective bore circumferential surface of a respective bore 46 has copper plating 50. The copper plating 50 forms a copper sleeve on the bore circumferential surface of a respective bore 46 and is created, for example, via a process of galvanizing copper on the bore circumferential surface. The copper sleeve formed by the copper plating 50 extends essentially along the bore axis 48 of a respective bore 46 and thus in the specific example of FIG. 2 perpendicularly to the air gap axis 37. The copper plating 50 is made from metal, namely copper, which is characterized by a particularly high thermal conductivity, in particular thermal conduction. It is consequently possible to effectively dissipate heat which is created, for example, during operation of the transformer 10, and to be precise in particular from the air gap 36 in the direction of the direction of extent of the copper plating 50 or in the direction of the bore axis 48. Heat can thus be effectively dissipated from the air gap 36 outward in the direction of the central limb portions 28, 34. Because in the specific example of FIG. 2, the air gap 36 is situated centrally between the two central limb portions 28, 34 and thus centrally in the transformer 10, effective dissipation of heat can be effected by means of the copper plating 50 from the center of the transformer 10 into the edge regions of the transformer 10 or outward (or upward and downward).

As can also be seen in FIG. 2, the bores 46 are filled with an electrically non-conductive filling material 52. The electrically non-conductive filling material can, for example, be a polymer material which is characterized by a higher thermal conductivity than air. The dissipation of heat can consequently be further improved.

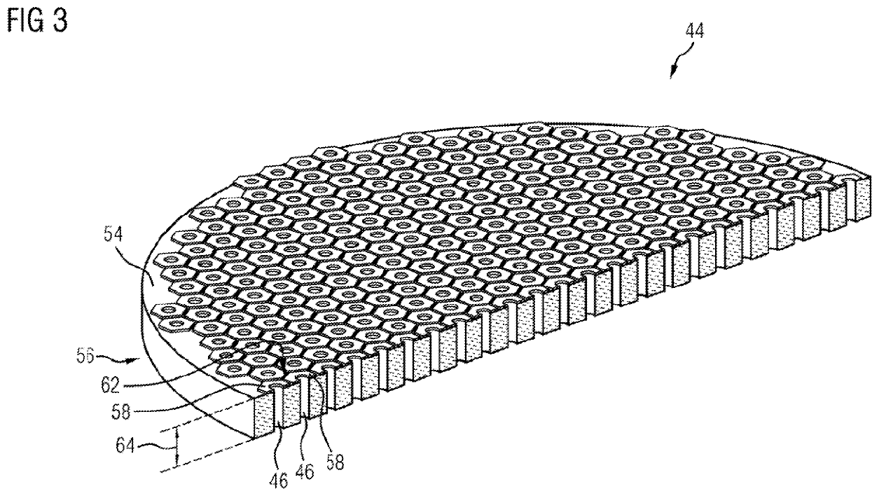

As is moreover shown in FIG. 2 and in more detail in FIG. 3, the insulation element 44 has copper cladding 58, connected to the copper plating 50, on an upper side 54 and on a lower side 56 in the region of a respective bore 46. The copper cladding 58 finally increases an end surface area of the copper plating 50 or an end surface area of the copper sleeves created by the copper plating 50 and consequently increases a thermally conductive end surface area on the upper side 54 or lower side 56 of the insulation element 44. As is moreover shown in detail in connection with FIG. 3, the bores 46 which extend through the insulation element 44 are not electrically connected to one another. The copper cladding 58, which in the specific example of FIG. 2 is situated on the upper side 54 and the lower side 56 of the insulation element 44, is also formed in such a way that an electrical connection of the respective bores 46 to one another is not present. In other words, the respective bores 46 are electrically insulated from one another despite the copper cladding 58 which is present.

As is moreover shown in FIG. 2, an adhesive layer 60 is situated between the insulation element 44 and the inner walls, forming or delimiting the air gap 36, of the central limb 18. The adhesive layer 60 serves to compensate tolerances and enables wide-area contact and thus essentially wide-area thermal conduction between the insulation element 44 and the inner walls of the central limb 18. The adhesive layer 60 can be applied by means of an adhesive such as, for example, a polymer adhesive or alternatively by means of an adhesive film.

Reference is now to be made to the already mentioned FIG. 3 which shows a schematic view of the insulation element 44.

As can be seen in FIG. 3, the bores 46, two of which are provided by way of example in FIG. 3 with the reference sign 46, are arranged in a pattern. The pattern enables uniform thermal conduction over the cross-sectional surface area of the insulation element 44. In the specific example of FIG. 3, the pattern is a hexagonal pattern which is characterized by a particularly high packing density in the insulation element 44. FIG. 3 shows in addition the already mentioned copper cladding 58 which is situated on the upper side 54 and on the lower side 56 of the insulation element 44. As can be readily seen in FIG. 3, the copper cladding 58 is not continuous and instead has, between adjacent bores 46, interruptions or gaps 62 which ensure electrical insulation of the bores 46 from one another. The interruptions or gaps 62 can be applied via etching processes or via photostructured templates on the upper side 54 or lower side 56 of the insulation element 44. The copper cladding 58 can also additionally be realized with plating when plating the bores 46.

As can in addition be seen in FIG. 3, the copper cladding 58 has a hexagonal shape in the region of a respective bore 46. By means of the hexagonal shape, the upper side 54 or the lower side 56 can be optimally covered such that an end thermally conductive surface area on the upper side 54 or lower side 56 of the insulation element 44 can be maximized.

A glass fiber-reinforced resin element described in connection with FIGS. 1 to 3 typically has a thickness 64 in a range from approximately 0.8 mm to 2 mm. An insulation element 44 formed from a glass fiber-reinforced resin element can thus be used, for example, as filling material for filling an air gap 36 which has a thickness in a range from approximately 0.8 mm to 2 mm (depending on how thick an adhesive layer 60, which may be present, is).

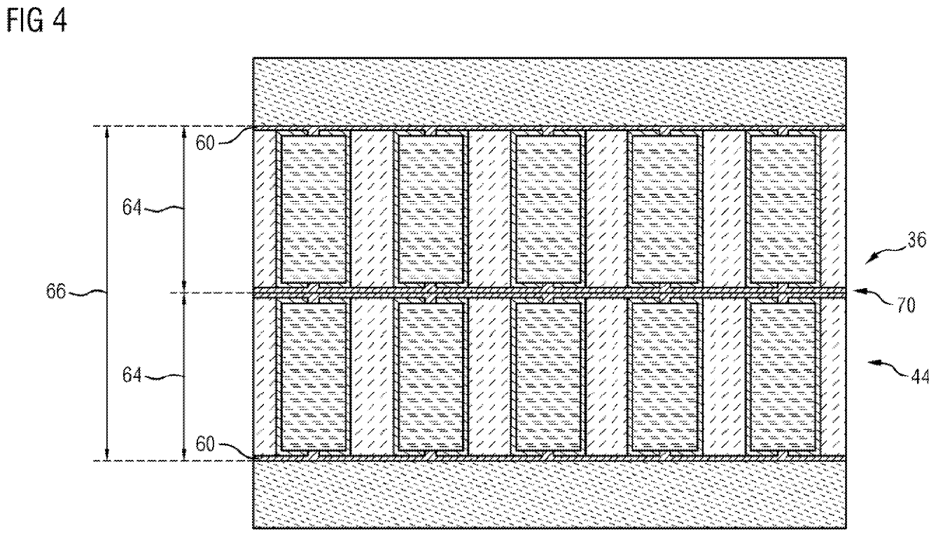

Reference should now be made to FIG. 4 which shows a schematic detailed view of a transformer 10 in which the air gap 36 has a thickness or height 66 which is a multiple of the already described thickness 64. In the specific example of FIG. 4, the thickness 66 of the air gap 36 is twice as large as the thickness 64 of an already described individual glass fiber-reinforced resin element according to FIGS. 1 to 3. In order to fill an air gap 36 with such a thickness 66, in the embodiment of FIG. 4 the insulation element 44 consists of two glass fiber-reinforced resin elements which are arranged one above the other, are connected to each other, and each have the thickness 64. The two glass fiber-reinforced resin elements which are arranged one above the other and connected to each other can in turn be connected to each other over a wide area by means of an adhesive layer 70. The exact thickness 66 of the air gap 36 to be filled is a result of the thickness 64 of the glass fiber-reinforced resin elements and the adhesive layers 60, 70 which may be present. Other thicknesses 66 of the air gap 36 can of course also be implemented by a corresponding combination of a plurality of glass fiber-reinforced resin elements. It is also not necessary for both glass fiber-reinforced resin elements to have the same thickness.

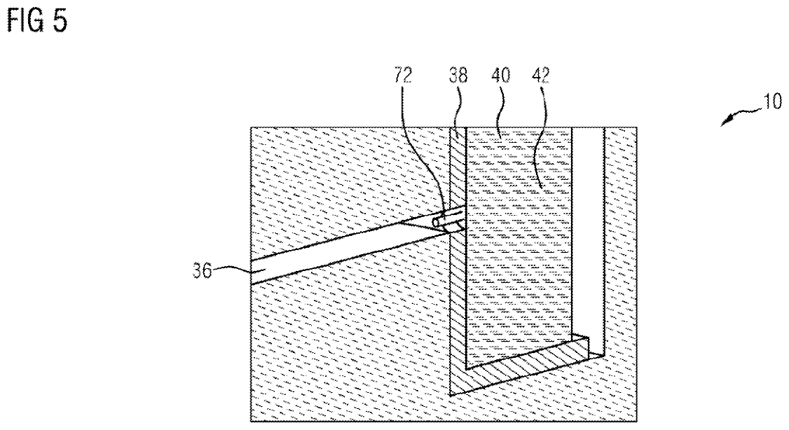

Reference should now be made to FIG. 5, which shows a schematic detailed view of a further embodiment of the transformer 10.

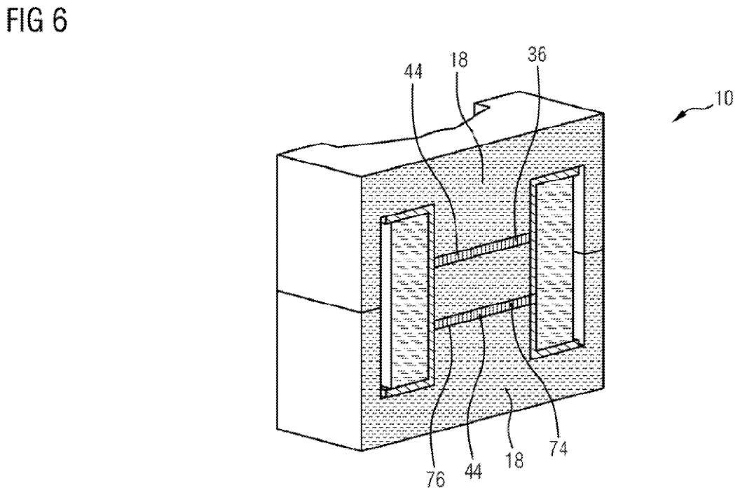

In the embodiment according to FIG. 5, the winding carrier 38 which serves to hold the windings 40, 42 has a recess 72 which serves as a connection path for connection of a sensor. The sensor, which is provided by way of example in connection with FIG. 6 with the reference sign 74, can be accommodated in the insulation element 44 and serves to determine a parameter which is characteristic for the transformer 10, such as for example a temperature or a magnetic field strength in the air gap 36.

Reference should now be made to FIG. 6, which shows a schematic detailed view of a further embodiment of the transformer 10.

The abovementioned sensor 74 is indicated schematically in the embodiment according to FIG. 6. As is also shown in FIG. 6, the central limb 18 has, in addition to the already described air gap 36 which is filled with the insulation element 44, a further air gap 76 which is filled with a further insulation element 44. Because in the embodiment according to FIG. 6 the transformer 10 has a plurality of air gaps separated and spaced apart from one another, and in the specific example of FIG. 6 has two air gaps 36, 76 which are each filled with an insulation element 44, a leakage inductance of the transformer 10 can be adapted to the respective use case. It is of course conceivable that, in other embodiments which have not been shown, more than two air gaps are present in the central limb 18. It is additionally conceivable that, depending on the use case, the respective air gaps can have different or the same heights or thicknesses. Lastly, it is conceivable that, for the respective use case, a respective air gap with a respective thickness or height can be filled by the combination of a plurality of glass fiber-reinforced resin elements which are arranged one above the other and are connected to one another, in particular adhesively bonded to one another.

1. A transformer comprising:
a magnetic core structure which has two side limbs and one central limb connected to the side limbs,
a first winding arranged around the central limb, and
a second winding arranged around the central limb, wherein the central limb has an air gap which is filled with an electrically non-conductive and magnetically non-conductive insulation element which has a plurality of bores extending through the insulation element and provided with copper plating, wherein the bores are not electrically connected to one another and extend perpendicularly to the air gap.

2. The transformer as claimed in claim 1, wherein the insulation element is a glass fiber-reinforced resin element, in particular a printed circuit board.

3. The transformer as claimed in claim 1, wherein the plurality of bores are arranged in the insulation element in a uniform pattern.

4. The transformer as claimed in claim 3, wherein the pattern is a hexagonal pattern.

5. The transformer as claimed in claim 1, wherein the insulation element has copper cladding, connected to the copper plating, on an upper side and/or a lower side.

6. The transformer as claimed in claim 5, wherein the copper cladding has a hexagonal shape in the region of a respective bore.

7. The transformer as claimed in claim 1, wherein an adhesive layer is present between the insulation element and inner walls, forming the air gap, of the central limb.

8. The transformer as claimed in claim 1, wherein the insulation element consists of a plurality of glass fiber-reinforced resin elements which are arranged one above the other and are connected to one another.

9. The transformer as claimed in claim 1, wherein the bores are filled with an electrically non-conductive filling material.

10. The transformer as claimed in claim 1, wherein the insulation element has a sensor for determining a parameter which is characteristic for the transformer.

11. The transformer as claimed in claim 10, wherein the transformer has a winding carrier, arranged around the central limb, for holding the first winding and for holding the second winding, and the winding carrier has a recess which is formed as a connection path for connection of the sensor.

12. The transformer as claimed in claim 1, wherein the magnetic core structure is formed from two identical magnetic core elements and the air gap is formed centrally between the two magnetic core elements.

13. The transformer as claimed in claim 1, wherein the central limb has a further air gap which is filled with a further electrically non-conductive and magnetically non-conductive insulation element which for its part has a plurality of bores provided with copper plating and not electrically connected to one another.

14. A printed circuit board for use in a transformer, the printed circuit board formed as a glass fiber-reinforced resin element and comprising a plurality of bores provided with a copper plating and not electrically connected to one another as an electrically non-conductive and magnetically non-conductive insulation element in an air gap formed in a central limb of a magnetic core structure of the transformer.

15. The transformer as claimed in claim 2, wherein the plurality of bores are arranged in the insulation element in a uniform pattern.

16. The transformer as claimed in claim 15, wherein the pattern is a hexagonal pattern.

17. The transformer as claimed in claim 2, wherein the insulation element has copper cladding, connected to the copper plating, on an upper side and/or a lower side.

18. The transformer as claimed in claim 17, wherein the copper cladding has a hexagonal shape in the region of a respective bore.

19. The transformer as claimed in claim 2, wherein the central limb has a further air gap which is filled with a further electrically non-conductive and magnetically non-conductive insulation element which for its part has a plurality of bores provided with copper plating and not electrically connected to one another.
